(19) United States
(12) Patent Application Publication
(10) Pub. No.: US 2006/0203839 A1
(43) Pub. Date: Sep. 14, 2006

(54) Image forming apparatus and method of controlling the same

(75) Inventor: Ryo Yoshida, Izunokuni-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/224,800

(22) Filed: Sep. 12, 2005

(30) Foreign Application Priority Data
Mar. 11, 2005 (JP) 2005-069922

(51) Int. Cl. H04L 12/42

(52) U.S. Cl. 370/452

(57) ABSTRACT

A MAC address required for data transmission and reception via a communication network is generated from a manufacturer's serial number of an image forming apparatus.

### CROSS-REFERENCE TO RELATED APPLICATIONS

This application is based upon and claims the benefit of priority from prior Japanese Patent Application No. 2005-069922, filed Mar. 11, 2005, the entire contents of which are incorporated herein by reference.

### BACKGROUND OF THE INVENTION

1. Field of the Invention

The present invention relates to an image forming apparatus having a function of transmitting and receiving data via a communication network, and a method of controlling the apparatus.

2. Description of the Related Art

There is a composite image forming apparatus (referred to as MFP) having a plurality of functions such as a facsimile function, a network scanning function, and a network printing function in addition to a usual copying function.

The facsimile function is a function of transmitting and receiving image data obtained by scanning of a draft with respect to an external apparatus such as a facsimile transmitter/receiver via a telephone circuit or a communication network (internet, LAN, etc.).

The network scanning function and the network printing function are functions of transmitting and receiving the image data obtained by the scanning of the draft or image data stored (memorized) in the image forming apparatus with respect to an external apparatus such as a personal computer or another image forming apparatus via the communication network.

To realize these functions, a network adapter and a network control section are mounted on the image forming apparatus. The network adapter is a network interface card (NIC) such as a commercially available LAN card, and is connected to the communication network to perform data transmission and reception with respect to the communication network. The network control section controls the data transmission and reception.

A media access control address (MAC address) is required for performing the data transmission and reception. This MAC address is stored beforehand in a memory of the LAN card, and an exclusive-use ROM is prepared for setting (writing) the address (see, e.g., Jpn. Pat. Appln. KOKAI Publication No. 2000-30479).

On the other hand, an inherent manufacturer's serial number is set to each image forming apparatus. The MAC address is also inherent in each image forming apparatus. A label on which the manufacturer's serial number is described and a label on which the MAC address is described are attached to the image forming apparatus in order to manage the manufacturer's serial number and the MAC address.

In a situation in which the manufacturer's serial number and the MAC address are managed by two labels as described above, a laborious operation of preparing two labels and attaching the two prepared labels to the apparatus, respectively, is required for a manufacturing stage of the image forming apparatus. Therefore, there is a problem that an operation efficiency in the manufacturing stage declines.

Moreover, when the network interface card (NIC) such as the LAN card is incorporated as hardware in a control substrate of a main body, both of the manufacturer's serial number and the MAC address are managed with respect to one control substrate, and the management is complicated.

### BRIEF SUMMARY OF THE INVENTION

The present invention has been developed in consideration of the above-described situations, and an object thereof is to provide an image forming apparatus and a method of controlling the apparatus in which a manufacturer's serial number and a MAC address can be managed only with the manufacturer's serial number, so that laborious operations such as preparing and attaching of a label are reduced as much as possible to improve an operation efficiency.

The present invention is directed to an image forming apparatus to which a manufacturer's serial number is set, comprising a network control section which controls data transmission and reception via a communication network; and a generation control section which generates a MAC address required for the data transmission and reception from the manufacturer's serial number.

According to the present invention, there is provided a method of controlling an image forming apparatus to which a manufacturer's serial number is set, comprising: controlling data transmission and reception via a communication network; and generating a MAC address required for controlling the data transmission and reception from the manufacturer's serial number.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an appearance of each embodiment;

FIG. 2 is a diagram showing a constitution of a control panel of each embodiment;

FIG. 3 is a block diagram of a control circuit according to a first embodiment;

FIG. 4 is a flowchart showing an operation of the first embodiment;

FIG. 5 is a diagram showing a format of a manufacturer's serial number in each embodiment;

FIG. 6 is a diagram showing a format of a MAC address in each embodiment;

FIG. 7 is a diagram showing a relation between the manufacturer's serial number and the MAC address in each embodiment;

FIG. 8 is a block diagram of the control circuit according to a second embodiment;

FIG. 9 is a flowchart showing MAC address generation at a shipping time according to the second embodiment; and

FIG. 10 is a flowchart showing an operation after the shipping according to the second embodiment.

### DETAILED DESCRIPTION OF THE INVENTION

[1] A first embodiment of the present invention will be described with reference to the drawings.

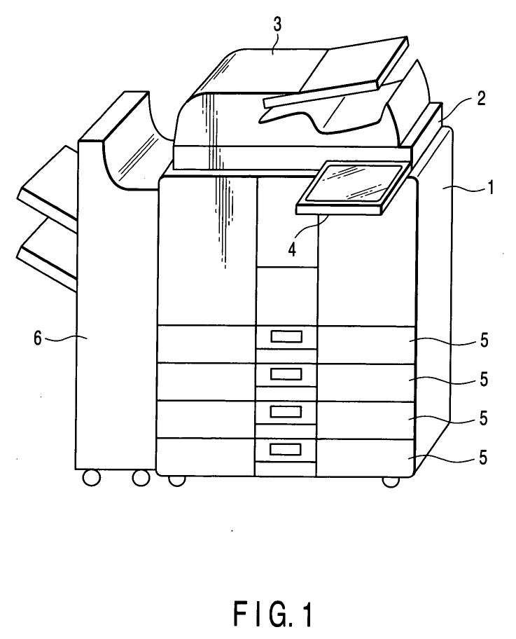

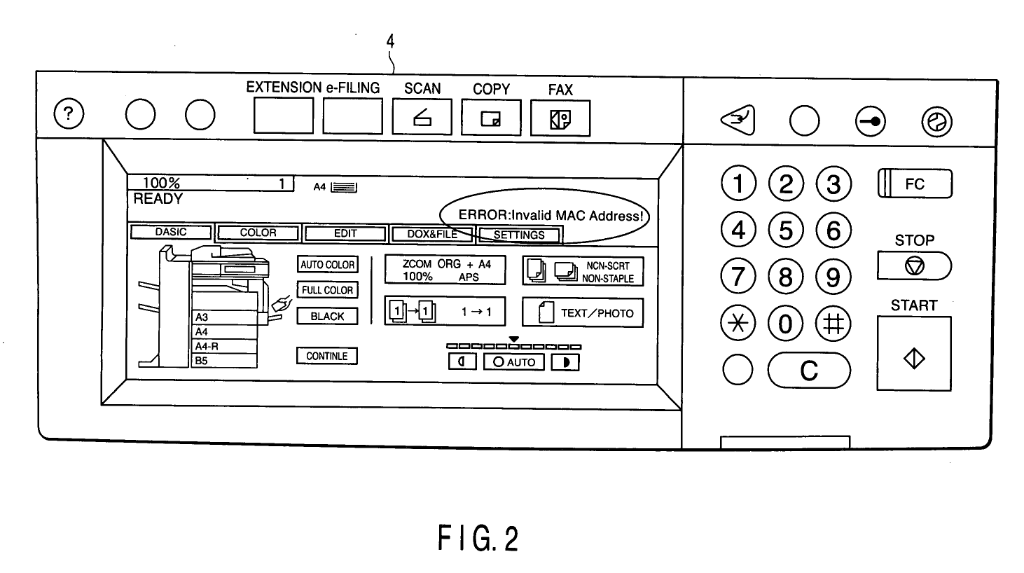

As shown in FIG. 1, a draft base 2 is disposed on an upper part of a main body 1 of an image forming apparatus, and an automatic draft feeder (ADF) 3 is openably disposed on the draft base 2. A control panel 4 shown in FIG. 2 is disposed as operating means for setting operating conditions in a position as high as that of the draft base 2. The control panel 4 is provided with a liquid crystal display screen in addition to various types of keys such as a start key, a stop key, ten keys, a scan key, a copy key, and a facsimile key.

In a lower part of the main body 1, there are disposed a plurality of cassettes 5 in which paper sheets having various types of sizes are stored as image forming mediums. In a side part of the main body 1, there is disposed a paper discharge unit 6 which receives printed and discharged paper sheets.

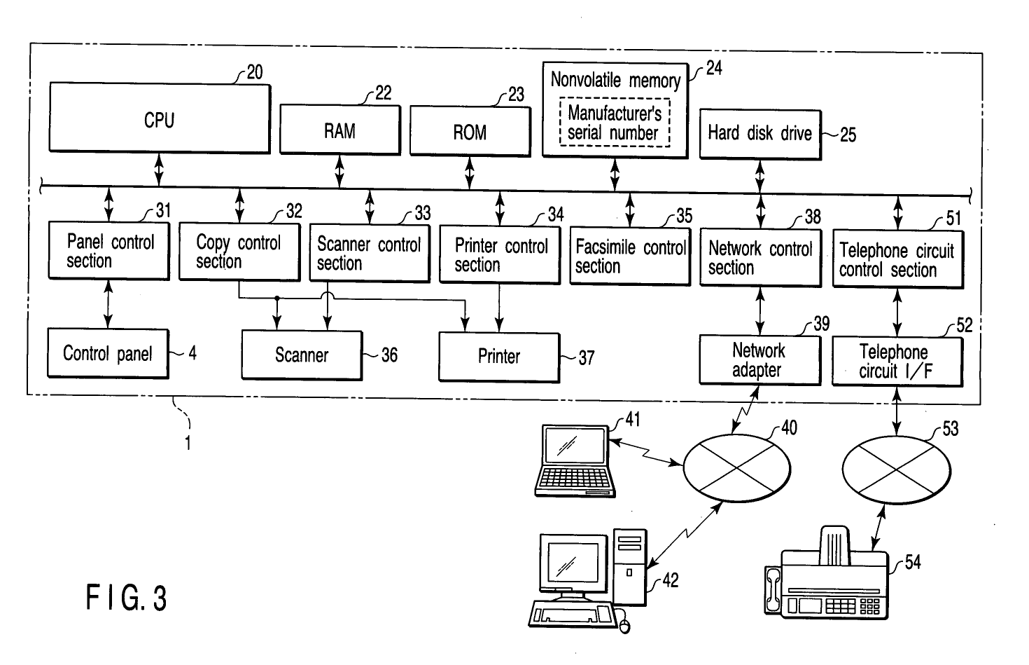

Moreover, as shown in FIG. 3, a CPU 20 which is a main control section is disposed in the main body 1. This CPU 20 is connected to a RAM 22, a ROM 23, a nonvolatile memory 24, a hard disk drive 25, a panel control section 31, a copy control section 32, a scanner control section 33, a printer control section 34, a facsimile control section 35, a network control section 38, and a telephone circuit control section 51.

The RAM 22 is a memory for temporarily storing a program or data to be processed by the CPU 20. Various types of control programs required for starting the main body 1 are stored in the ROM 23. Various types of data including a manufacturer's serial number inherent in the main body 1 are stored in the nonvolatile memory 24 at a time of manufacturing of the main body 1. Image data scanned in the main body 1 is stored in the hard disk drive 25.

A panel control section 31 controls the control panel 4. The copy control section 32 controls a usual copy function using a scanner 36 and a printer 37. The scanner control section 33 controls scanning functions (scan to box function, scan to file function, scan to E-mail function) using the scanner 36. The printer control section 34 controls a network printing function using the printer 37.

The facsimile control section 35 controls facsimile transmission and reception by the network control section 38 and the telephone circuit control section 51.

The network control section 38 controls data transmission and reception with respect to a communication network 40 via a network adapter 39. The communication network 40 is connected to external apparatuses such as personal computers 41, 42.

The telephone circuit control section 51 controls communication with a public telephone circuit 53 via a telephone circuit interface 52. This control enables facsimile transmission and reception with respect to an external facsimile device 54.

On the other hand, the CPU 20 has the following means (1), (2) as main functions:

(1) generating means for generating a MAC address required for the data transmission and reception via the network adapter from the manufacturer's serial number stored in the nonvolatile memory 24 every starting of the main body 1; and

(2) setting means for successively setting the generated MAC address to the network control section 38.

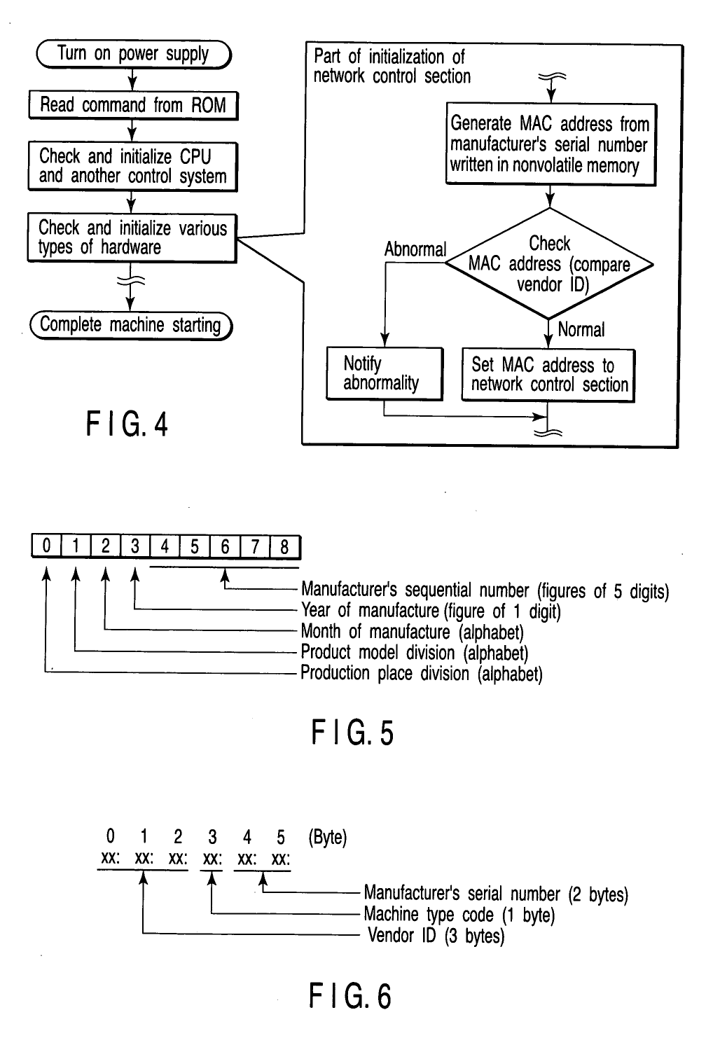

An operation will be described with reference to a flowchart of FIG. 4.

When a power supply of the main body 1 is turned on, commands based on various types of control programs are read from the ROM 23. Based on this command, the CPU 20 and another control system are checked and initialized, and various types of hardware are checked and initialized. The initialization also includes initialization of the network control section 38 which is a network device.

In the initialization of the network control section 38, the MAC address required for the data transmission and reception via the network adapter 39 is generated from the manufacturer's serial number in the nonvolatile memory 24, and it is checked whether or not the generated MAC address is normal. If the generated MAC address is normal, it is set to the network control section 38. Accordingly, preparation for the data transmission and reception is completed.

If the generated MAC address is abnormal, this effect is notified by display of an error in the liquid crystal display screen of the control panel 4. An example of this error display is shown in FIG. 2.

An abnormality of the manufacturer's serial number used in the generation is considered as a cause for an abnormality of the generated MAC address. As a cause for the abnormality of the manufacturer's serial number, there is considered an input mistake of the manufacturer's serial number with respect to the nonvolatile memory 24, or an abnormality of the nonvolatile memory 24.

A format of the manufacturer's serial number is shown in FIG. 5, and that of the MAC address is shown in FIG. 6.

The manufacturer's serial number is constituted of: an item of a production place division (alphabetical character) corresponding to a place of manufacture; an item of a product model division (alphabetical character); item of month (1 to C) of manufacture; an item of year (0 to 9) of manufacture; and an item of a manufacturer's sequential number (figures of 5 digits) successively set every manufacturing.

The MAC address is formed by a combination of a vendor ID (3 bytes) of a manufacturer of the image forming apparatus, a machine type code (1 byte) of the apparatus, and numerical value data (2 bytes) obtained by adding a predetermined number to the manufacturer's sequential number of the manufacturer's serial number.

Since the manufacturer's serial number itself is inherent in each image forming apparatus, the numerical value data obtained by adding the predetermined number to the manufacturer's serial number is similarly inherent in each image forming apparatus.

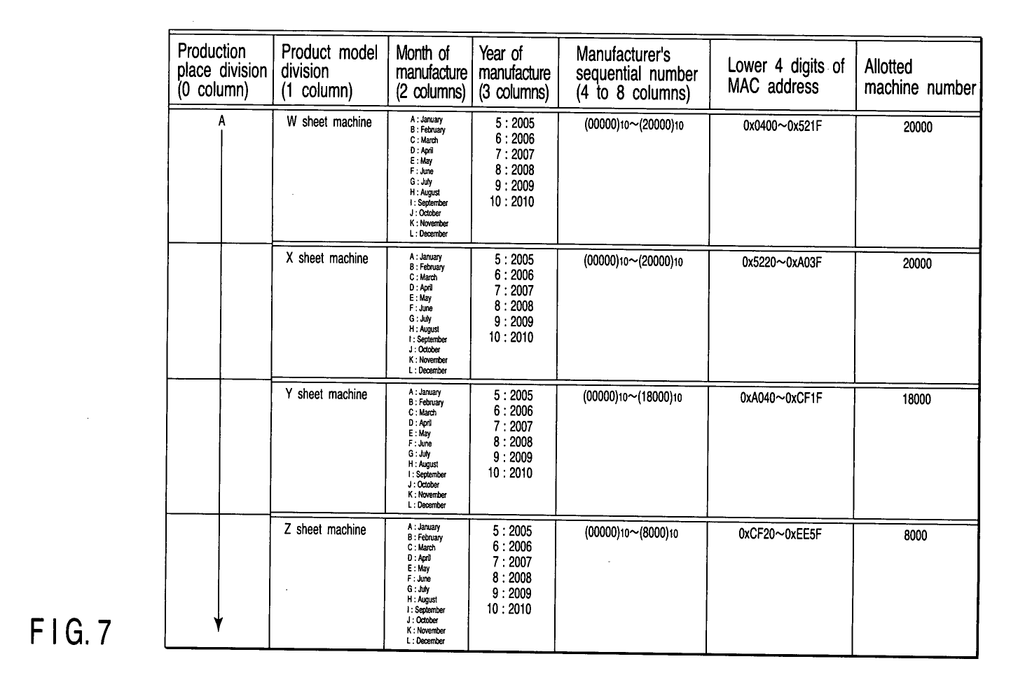

A relation between the manufacturer's serial number and the MAC address is shown in FIG. 7. The manufacturer's sequential number in the manufacturer's serial number is denoted with a decimal number, and lower four digits of the numerical value data in the MAC address are denoted with a hexadecimal number.

With regard to 20000 image forming apparatuses having a product model division “W sheet machine”, (00000)₁₀ to (20000)₁₀ are set as the manufacturer's sequential numbers. As the predetermined number, 0x0400 (offset value) is added to each of these manufacturer's sequential numbers. According to this addition, 0x0400 to 0x521F are obtained as the lower four digits of the numerical value data which is an element forming the MAC address.

With regard to 20000 image forming apparatuses having a product model division “X sheet machine”, (00000)₁₀ to (20000)₁₀ are set as the manufacturer's sequential numbers. As the predetermined number, 0x5220 (offset value) is added to each of these manufacturer's sequential numbers. According to this addition, 0x5220 to 0xA03F are obtained as the lower four digits of the numerical value data which is the element forming the MAC address.

With regard to 18000 image forming apparatuses having a product model division “Y sheet machine”, (00000)₁₀ to (18000)₁₀ are set as the manufacturer's sequential numbers. As the predetermined number, 0xA040 (offset value) is added to each of these manufacturer's sequential numbers. According to this addition, 0xA040 to 0xCF1F are obtained as the lower four digits of the numerical value data which is the element forming the MAC address.

With regard to 8000 image forming apparatuses having a product model division “Z sheet machine”, (00000)₁₀ to (8000)₁₀ are set as the manufacturer's sequential numbers. As the predetermined number, 0xCF20 (offset value) is added to each of these manufacturer's sequential numbers. According to this addition, 0xCF20 to 0xEE5F are obtained as the lower four digits of the numerical value data which is the element forming the MAC address.

As described above, since the MAC address required for the data transmission and reception is generated from the manufacturer's serial number every starting of the main body 1, the manufacturer's serial number and the MAC address can be managed only with the manufacturer's serial number. As a label for management, an only label may be prepared on which the manufacturer's serial number is described. Unlike the conventional art, it is not necessary to prepare two labels for the manufacturer's serial number and the MAC address. Therefore, laborious operations such as preparing and attaching of the label can be reduced as much as possible, and an operation efficiency in a manufacturing stage is largely improved.

Moreover, since the MAC address is generated every starting of the main body 1, storage means for the MAC address is unnecessary, and costs can be reduced.

It is to be noted that the predetermined number is added to the manufacturer's sequential number of the manufacturer's serial number to generate the MAC address, but a predetermined number may be subtracted from the manufacturer's sequential number of the manufacturer's serial number to generate the MAC address.

[2] A second embodiment will be described.

A CPU 20 has the following means (11) and (12) as main functions:

(11) generating means for generating a MAC address required for data transmission and reception via a network adapter from a manufacturer's serial number stored in a nonvolatile memory 24 to store the address in the nonvolatile memory 24 before shipping of a main body 1; and

(12) setting means for setting the MAC address stored in the nonvolatile memory 24 to a network control section 38 every starting of the main body 1.

Since another constitution is the same as that of the first embodiment, description thereof is omitted.

First, the manufacturer's serial number is stored in the nonvolatile memory 24 during manufacturing of the main body 1. A format of the manufacturer's serial number is the same as that shown in FIG. 5.

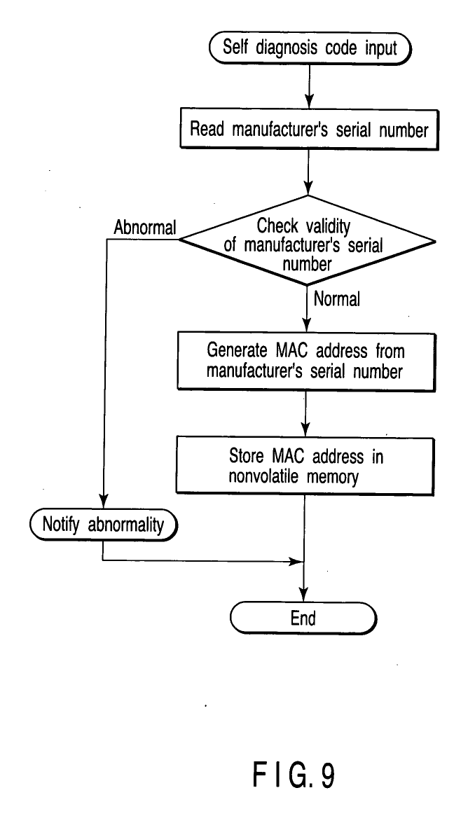

When the manufacturing of the main body 1 is completed, an operator inputs a self diagnosis code into a control unit 4 as one of inspections before the shipping. In response to this input, as shown in a flowchart of FIG. 9, the manufacturer's serial number is read from the nonvolatile memory 24, and the read manufacturer's serial number is checked.

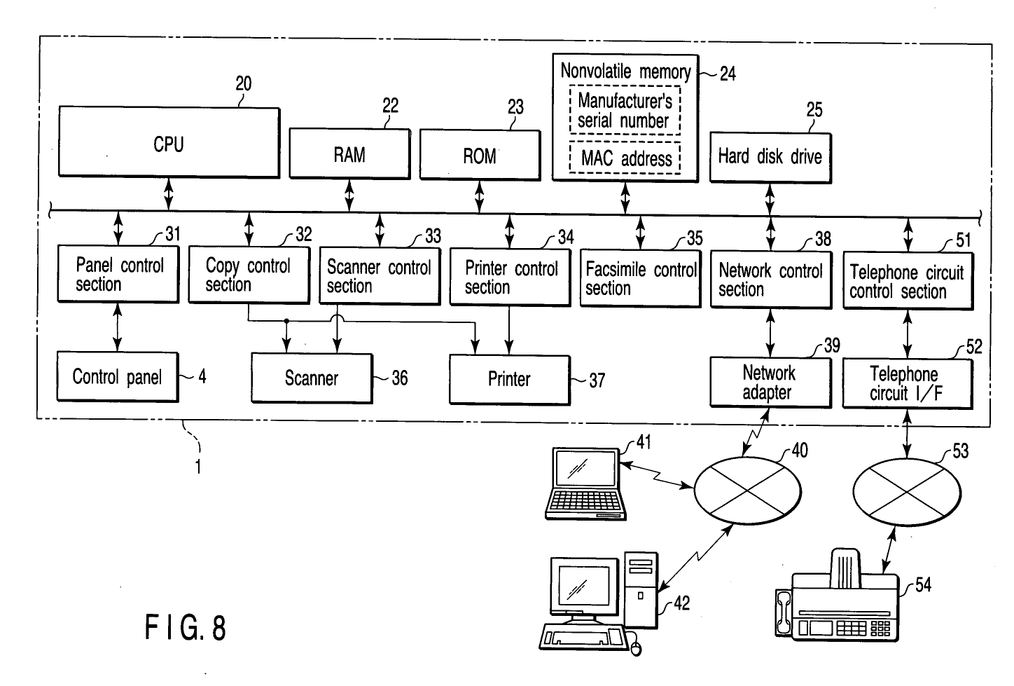

When the manufacturer's serial number is normal, the MAC address required for the data transmission and reception via the network adapter 39 is generated from the manufacturer's serial number. A format of the MAC address is the same as that shown in FIG. 6. The generated MAC address is stored (memorized) in the nonvolatile memory 24 as shown in FIG. 8.

When the manufacturer's serial number is abnormal, this effect is notified by error display in a liquid crystal display screen in the control panel 4. This error display is shown in FIG. 2.

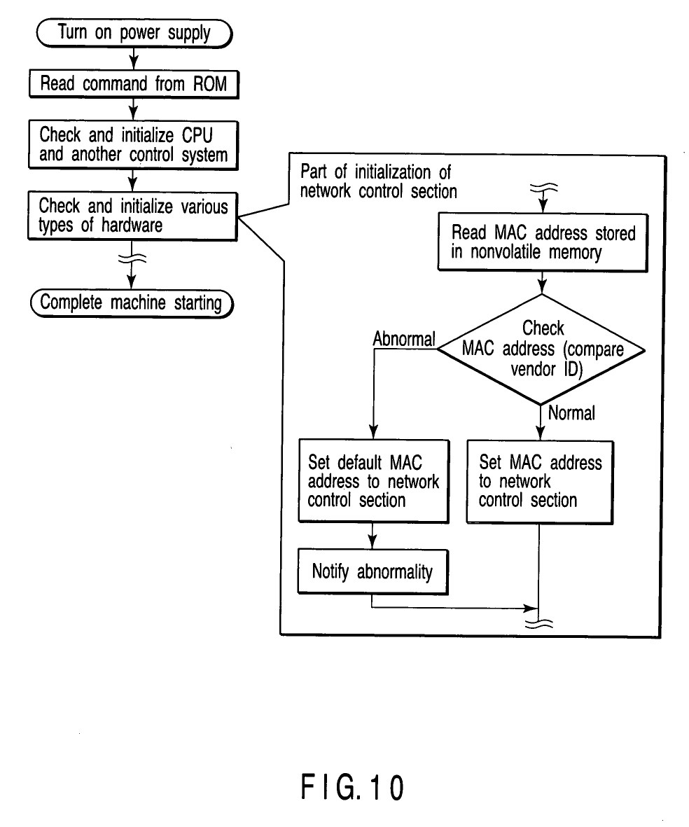

Next, an operation after the shipping will be described with reference to a flowchart of FIG. 10.

When a power supply of the main body 1 is turned on, commands based on various types of control programs are read from a ROM 23. Based on this command, the CPU 20 and another control system are checked and initialized, and various types of hardware are checked and initialized. The initialization also includes initialization of the network control section 38 which is a network device.

In the initialization of the network control section 38, the MAC address stored in the nonvolatile memory 24 is read, and it is checked whether or not the read MAC address is normal. If the read MAC address is normal, it is set to the network control section 38. Accordingly, preparation for the data transmission and reception is completed.

If the read MAC address is abnormal, a default MAC address stored in the nonvolatile memory 24 is set to the network control section 38. The default MAC address is prepared beforehand for emergency in order to establish a data transmission and reception mode, and stored together with the manufacturer's serial number in the nonvolatile memory 24 at a time of manufacturing of the main body 1.

As described above, since the MAC address required for the data transmission and reception is generated from the manufacturer's serial number and stored in the nonvolatile memory 24 at the time of the manufacturing of the main body 1, and the MAC address in the nonvolatile memory 24 is set to the network control section 38 every starting of the main body 1, the manufacturer's serial number and the MAC address can be managed only with the manufacturer's serial number.

An only label on which the manufacturer's serial number is described may be prepared as a label for management, and two labels for the manufacturer's serial number and the MAC address do not have to be prepared unlike the conventional art. Therefore, laborious operations such as preparing and attaching of the label can be reduced as much as possible, and an operation efficiency in a manufacturing stage is largely improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming apparatus to which a manufacturer's serial number is set, comprising:
a network control section which controls data transmission and reception via a communication network; and
a generating section which generates a MAC address required for the data transmission and reception from the manufacturer's serial number.

2. The image forming apparatus according to claim 1, wherein the MAC address is formed by a combination of a vendor ID of a manufacturer of the apparatus, a machine type code of the apparatus, and numerical value data obtained by adding a predetermined number to the manufacturer's serial number.

3. The image forming apparatus according to claim 1, wherein the generating section generates the MAC address every starting of the apparatus.

4. The image forming apparatus according to claim 1, wherein the generating section generates and stores the MAC address before shipping of the apparatus.

5. An image forming apparatus to which a manufacturer's serial number is set, comprising:
a network control section which controls data transmission and reception via a communication network;
a generating section which generates a MAC address required for the data transmission and reception from the manufacturer's serial number; and
a setting section which sets the MAC address generated by the generating section to the network control section.

6. The image forming apparatus according to claim 5, wherein the MAC address is formed by a combination of a vendor ID of a manufacturer of the apparatus, a machine type code of the apparatus, and numerical value data obtained by adding a predetermined number to the manufacturer's serial number.

7. The image forming apparatus according to claim 5, wherein the generating section generates the MAC address every starting of the apparatus, and
the setting section sets the MAC address to the network control section every starting of the apparatus.

8. The image forming apparatus according to claim 5, wherein the generating section generates and stores the MAC address before shipping of the apparatus, and
the setting section sets the stored MAC address to the network control section every starting of the apparatus.

9. An image forming apparatus to which a manufacturer's serial number is set, comprising:
a network adapter connected to a communication network to perform data transmission and reception via the communication network;
a network control section which controls the data transmission and reception;
a generating section which generates a MAC address required for the data transmission and reception from the manufacturer's serial number; and
a setting section which sets the MAC address generated by the generating section to the network control section.

10. The image forming apparatus according to claim 9, wherein the MAC address is formed by a combination of a vendor ID of a manufacturer of the apparatus, a machine type code of the apparatus, and numerical value data obtained by adding a predetermined number to the manufacturer's serial number.

11. The image forming apparatus according to claim 9, wherein the generating section generates the MAC address every starting of the apparatus, and
the setting section sets the MAC address to the network control section every starting of the apparatus.

12. The image forming apparatus according to claim 9, wherein the generating section generates and stores the MAC address before shipping of the apparatus, and
the setting section sets the stored MAC address to the network control section every starting of the apparatus.

13. A method of controlling an image forming apparatus to which a manufacturer's serial number is set, comprising:
controlling data transmission and reception via a communication network; and
generating a MAC address required for controlling the data transmission and reception from the manufacturer's serial number.
